(19) United States
(12) Patent Application Publication
(10) Pub. No.: US 2025/0156484 A1
(43) Pub. Date: May 15, 2025

(54) DEVIATION DETECTION AKA PLAYBOOK COMPARISON, SUMMARY FOR LEGAL TEAM

(71) Applicant: Thomson Reuters Enterprise Centre GmbH, Zug (CH)

(72) Inventor: Robert Rankin, Toronto (CA)

(21) Appl. No.: 18/948,253

(22) Filed: Nov. 14, 2024

Related U.S. Application Data
(60) Provisional application No. 63/598,892, filed on Nov. 14, 2023.

(51) Int. Cl. G06F 16/93; G06F 40/166; G06F 40/284

(52) U.S. Cl. CPC G06F 16/93; G06F 40/166; G06F 40/284

(57) ABSTRACT

This disclosure provides systems, methods, and devices for automatic comparison, analysis, and modification of documents using artificial intelligence and natural language processing-based techniques. In a first aspect, a method includes identifying a first set of document portions in a first document. The method includes generating a set of matched candidate pairs based on the first set of document portions and a set of pre-determined document portions distinct from the first set of document portions. The method includes quantifying relationships between the set of matched candidate pairs. The method includes modifying the first document to produce a second document including one or more new document portions, where the new documents portions correspond to one or more of the set of pre-determined document portions and replace at least one of the first set of documents portions.

### CROSS-REFERENCE TO RELATED APPLICATIONS

The present application claims the benefit of priority from U.S. Provisional Application No. 63/598,892 filed Nov. 14, 2023 and entitled “DEVIATION DETECTION AKA PLAYBOOK COMPARISON, SUMMARY FOR LEGAL TEAM,” the disclosure of which is incorporated by reference herein in its entirety.

### TECHNICAL FIELD

The present invention relates to the field of document processing technology and more specifically, to systems and methods supporting automatic comparison, analysis, and modification of documents using artificial intelligence and natural language processing-based techniques.

### BACKGROUND

Legal professionals, particularly corporate lawyers specializing in mergers and acquisitions, negotiations of million-dollar contracts, and other high-stakes services, need efficient methods to review and compare commercial contracts with respect to a company's legal playbook (e.g., guidelines). In the current practice, this process involves manual review and comparison of the contract provisions, which can be time-consuming and prone to human errors. It is also a subjective process where different reviewers may read provisions differently and therefore understand the terms of the contract to have different meanings. Such subjectivity may lead to incorrect changes to a document or other inadvertent consequences that may impact how the document is ultimately interpreted.

### BRIEF SUMMARY

Embodiments of the present disclosure provide systems, methods, and devices for automating the comparison, analysis, and modification of documents via support provided by artificial intelligence-based tools.

For example, the disclosed embodiments may facilitate comparison, analysis, and modification of provisions of a contract or other type of document based on a pre-determined playbook (e.g., best practices, guidelines, etc.). In particular, the techniques described herein may include taking or inputting multiple pairs of provisions (e.g., text passages), where one provision is from a contract and the other is from the playbook. The techniques described herein may include processes including taking matched pair of provisions (e.g., contract provision matched to playbook provision), and (1) ranking and flagging the provision pairs, (2) explaining the differences between the flagged provision pairs, and (3) modifying the contract text to bring it in compliance with the playbook.

As discussed herein, the system may receive a document as input and identify document portions (e.g., input document portions), such as passages of text, within the document. The document portions identified within the document may be compared to portions of the playbook (e.g., playbook document portions) to generate matched candidate pairs. In some examples, identifying the document portions may involve using a classification model that is based on training data associated with particular classes of documents. The classification model may include specific data for each type of a classification. For example, if the classification is an agreement, the different types of classification may include a sales agreement, an employment agreement, an oil and gas leasing agreement, and so forth. Accordingly, the document may be analyzed using the appropriate classification agreement to provide precise identification of different clauses and provision. In some examples, such as to reduce power consumption and reduce processing time of the system, identifying the document portions may involve a large language model that can be applied to any type of classification documents.

The matched candidate pairs may include a portion corresponding to a text passage (e.g., provision) from the input document (e.g., input document portion) and the other portion may include a text passage from the playbook (e.g., playbook document portion). The matched candidate pairs including the input document portion and the playbook document portion may be analyzed and compared to identify differences between the portions. In some examples, the matched candidate pairs may be ranked based on priority (e.g., ranked and flagged). In particular, the priority ranking may be determined by scoring each of the matched candidate pairs based on an intrinsic priority and/or a semantic deviation. Scoring for intrinsic priority may include assigning a low priority, a medium priority, or a high priority to a document portion pair, and the priority may be based on a category of the playbook document portion, where some categories are higher priority for review than other categories. Scoring for semantic deviation may include using a transformer model to compute semantic similarity or dissimilarity between the input document portion and the playbook document portion of the document portion pair. The intrinsic priority score and the semantic deviation score may be combined to produce a single priority score. The combined score may determine which matched candidate pairs have high priority, and the high priority matched candidate pairs may be flagged for review.

In some examples, the system may utilize artificial intelligence and natural language processing-based techniques to generate an explanation of the differences (e.g., explain top differences) between the input document portion and the playbook document portion of each of the matched candidate pairs. The system may suggest modifications to the contract (e.g., modify) to better align the contract with the playbook. For example, the alignment may be a strict alignment (e.g., input document portion text to be the same or approximately the same as the playbook document portion for the matched candidate pairs) or a flexible alignment (e.g., input document portion to be similar to the playbook document portion for the matched candidate pairs). The system may allow the user the select and/or revise the suggested modifications, facilitating modification of the contract to conform to the playbook, to be in accordance with negotiation preferences (e.g., flexible compliance), or both. Such suggested modifications may also be based on the least quantity of modifications to the contract that still allows the contract to be in line with preferred business policies (e.g., above a threshold compliance with policies).

In an aspect, a method is disclosed and includes identifying, by one or more processors, a first plurality of document portions (e.g., provisions and/or clauses) in a first document. The method also includes generating, by the one or more processors, a plurality of matched candidate pairs based on the first plurality of document portions and a plurality of pre-determined document portions distinct from the first plurality of document portions. For example, the first document may be a contract and the plurality of pre-determined document portions may correspond to the playbook. Each document portion pair may include a first document portion and a second document portion. The first document portion of a particular document portion pair may correspond to one of the first plurality of document portions and the second document portion of the particular document portion pair may correspond to one of the plurality of pre-determined document portions. For example, each document portion pair may include a document portion identified from an input document or text, such as the contract (e.g., a first document portion) and a document portion identified from a playbook (e.g., second document portion).

The method also includes determining, by the one or more processors, information representative of a relationship between the first document portion and the second document portion for each document portion pair. In an aspect, identifying the first plurality of document portions in the first document is based on a large language model applicable to a plurality of document classifications. In an aspect, identifying the first plurality of document portions in the first document is based on a trained classification model associated with a class of the first document.

In an aspect, the information representative of the relationship between the first document portion and the second document portion for each document portion pair may include, for each document portion pair of the plurality of matched candidate pairs, a first score corresponding to one or more intrinsic properties of the first document portion and the second document portion and a second score corresponding to a semantic difference between the first document portion and the second document portion. Intrinsic property may refer to a fundamental purpose of the clause as defined by its language (e.g., legal function of a clause within a contract) and/or a priori priority by clause or provision type as determined by a small and medium-sized enterprise and/or one or more large language models.

The method may also include generating, by the one or more processors, a set of embeddings for the plurality of matched candidate pairs. Each embedding of the set of embeddings may correspond to a particular document portion pair of the plurality of matched candidate pairs and the information representative of the relationship between the first document portion and the second document portion of each document portion pair may be determined based on the set of embeddings. In an aspect, the difference between the first document portion and the second document portion is determined based on the embeddings using a transformer model, such as a fine-tuned transformer model that is fine-tuned with the multi-objective goal of, including, but not limited to, retrieving contract passages that are similar to a query-passage. In an aspect, a first portion of the set of embeddings corresponding to the first document portion is configured as a query parameter for the transformer model and an attention mechanism of the transformer model is configured based on a second portion of the set of embeddings corresponding to the second document portion. In an aspect, the method includes pruning the set of embeddings to produce a pruned set of embeddings. The pruned set of embeddings may retain portions of the set of embeddings representative of on an output of the transformer model.

The method also includes generating, by the one or more processors, a priority score for each document portion pair of the plurality of matched candidate pairs based on the one or more intrinsic properties and the difference between the first document portion and the second document portion. In some examples, the difference may be determined based on a transformer model, such as a fine-tuned transformer model that is fine-tuned with the multi-objective goal of, including, but not limited to, classifying a contract-passage-pair as being materially different or immaterially different (e.g., paraphrased but same overall meaning).

In an aspect, the method may include ranking the plurality of matched candidate pairs based on the priority score. The method may also include quantifying, by the one or more processors, the relationships between the plurality of matched candidate pairs based on the information representative of the relationship between the first document portion and the second document portion for each document portion pair. The method also includes modifying, by the one or more processors, the first document to produce a second document having one or more new document portions. The one or more new documents portions may be associated with or correspond to one or more of the plurality of pre-determined document portions and may be used to replace at least one of the first plurality of documents portions.

The method may also include generating data describing legal differences between a first document portion of at least one document portion pair and a second document portion of the at least one document portion pair using at least one large language model. In an aspect, the at least one large language model may include a plurality of large language models, and the data describing the legal differences may be generated by different large language models of the plurality of large language models based on a ranking criterion. In an aspect, the data describing legal differences may include a summary, a natural language description of the difference, a sentence explaining risk arising from the legal differences, a sentence explaining potential liabilities arising from the legal differences, or a combination thereof. In an aspect, the method includes generating a prompt based on the first document, the plurality of pre-determined document portions, or both, where the prompt is provided as an input to at least one the large language model. In an aspect, the data describing the legal differences may include a threshold number of outputs, each output corresponding to a particular document portion pair of the plurality of matched candidate pairs. The threshold number of outputs may be configurable by a user. In some examples, each of the differences (e.g., differences generated using large language models) may be given a low, medium, or high confidence score. The score may provide an indication of the confidence level that the large language models have in generating the differences.

In an aspect, modifying the first document to produce the second document comprises applying a large language model to the first document. A prompt may be generated and provided to the large language model as input, where the prompt may include parameters for configuring the second document. For example, the parameters for configuring the second document may include a compliance parameter specifying whether the one or more new documents portions correspond to one or more of the plurality of pre-determined document portions or a compromise between a particular document portion of the first plurality of document portions and a corresponding one of the plurality of pre-determined document portions. The prompt may include one or more annotated matched candidate pairs configured to control generation of the one or more new document portions. The prompt may include contextual information associated with the first document, the plurality of pre-determined document portions, or both, where the contextual information is configured to control generation of the one or more new document portions. In some embodiments, systems and non-transitory computer-readable storage media configured to perform operations according to any of the above-described methods are disclosed.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawings, in which:

FIG. 1 is a block diagram of a system operating in accordance with aspects of the present disclosure.

FIG. 2 is a flow diagram for comparing and modifying documents in accordance with aspects of the present disclosure.

FIG. 3 is a flow diagram for processing a document in accordance with aspects of the present disclosure.

FIG. 4 is a flow diagram for comparing matched candidate pairs of the document in accordance with aspects of the present disclosure.

FIG. 5 is a flow diagram for matching matched candidate pairs of the document in accordance with aspects of the present disclosure.

FIG. 6 is a flow diagram for ranking matched candidate pairs of the document in accordance with aspects of the present disclosure.

FIG. 7 is a graph diagram for scoring matched candidate pairs of the document in accordance with aspects of the present disclosure.

FIG. 8 is a system diagram for analyzing and modifying matched candidate pairs of the document in accordance with aspects of the present disclosure.

FIG. 9 is an example of a suggested modification of the matched candidate pairs in accordance with aspects of the present disclosure.

FIG. 10 is a process flow of an exemplary method for automated document modification in accordance with aspects of the present disclosure.

It should be understood that the drawings are not necessarily to scale and that the disclosed embodiments are sometimes illustrated diagrammatically and in partial views. In certain instances, details which are not necessary for an understanding of the disclosed methods and apparatuses or which render other details difficult to perceive may have been omitted. It should be understood, of course, that this disclosure is not limited to the particular embodiments illustrated herein.

### DETAILED DESCRIPTION

Many professions, such as the legal profession, involve drafting, reviewing, and comparing documents, such as contracts. For example, a reviewer (e.g., a professional) may review a contract to determine if the contract aligns with a company playbook (e.g., best practices, guidelines, etc.). However, manually reviewing and comparing provisions of the document to the playbook may be time-consuming, as well as prone to human errors. The manually reviewing and comparing is also a subjective process, such that different reviewers may read and interpret provisions of the same contract and/or the playbook differently. The varying interpretations may result in incorrect changes to the contract or other inadvertent consequences that may impact interpretation of the contract.

To efficiently and precisely interpret a document in accordance with a pre-determined playbook, for example, for possible modifications to the document, the disclosed embodiments facilitate automatic comparison, analysis, and modification of clauses of a contract or other type of document based on the playbook. A system may receive a document as an input and identify document portions within the document (e.g., passages of text, such as one or more paragraphs of a document or a section of the document). The document portions identified within the document may be compared to portions of the playbook to generate matched candidate pairs.

In some examples, identifying the document portions may involve using a classification model (e.g., referred to herein as “thought-extractor”) that is based on training data associated with particular classes of documents. The classification model may include specific data for each type of a classification. For example, if the classification is an agreement, the different types of classification may include a sales agreement, an employment agreement, an oil and gas agreement, and so forth. Accordingly, the document may be analyzed using the appropriate classification agreement to provide precise identification of the document portions. In some examples, such as to reduce power consumption and reduce processing time of the system, identifying the document portions may involve a large language model that can be applied to any type of classification documents.

Each of the matched candidate pairs may include a portion corresponding to a provision, such as text passage, from the input document (e.g., input document portion) and the other portion may include a provision from the playbook (e.g., playbook document portion). The matched candidate pairs including the input document portion and the playbook document portion may be analyzed and compared to identify differences between the portions.

In some examples, each of the matched candidate pairs may be ranked based on a priority (e.g., ranked and flagged). In particular, the priority ranking may be determined by scoring a document portion pair based on an intrinsic priority and/or a semantic deviation. As discussed herein, the term “intrinsic property” may refer to a fundamental purpose of the clause as defined by its language (e.g., legal function of a clause within a contract) and/or a priori priority by clause or provision type as determined by a small and medium-sized enterprise (SME) and/or one or more large language models.

As discussed herein, different transformer models may be fine tuned for the various different tasks discussed herein, such as for classifying, scoring, etc. For example, a first transformer model may be trained to determine similarity or dissimilarity between pairs of paragraphs of an input document (e.g., a contract, an input document) to find and rank similar passages between the document portions of the input document and the playbook. The first transformer model may determine the semantic similarity or dissimilarity between the input document portion and the playbook document portion of the document portion pair. In some examples, the first transformer model may be combined or used with a term frequency-inverse document frequency (TF-IDF) model, which may determine similarity or dissimilarity between document portion pairs to score pairs. A second transformer model may be used for classifying the document portions (e.g., function as a classifier), such as by classifying document portion pairs as being materially different or immaterially different and ranking them to identify the classification. The second transformer model may be used for scoring for intrinsic priority. Scoring for intrinsic priority may include assigning a low priority, a medium priority, or a high priority to the document portion pair, and the priority may be based on a category of the playbook document portion. Scoring for semantic deviation may include using a transformer model to compute semantic similarity or dissimilarity between the input document portion and the playbook document portion of the document portion pair. The intrinsic priority score and the semantic deviation score may be combined to produce a single priority score that is used to whether the document portion pair has a priority level (e.g., high priority) that results in flagging for review.

In some examples, the system may utilize artificial intelligence and natural language processing-based techniques to generate an explanation of the differences (e.g., explain top differences) between the input document portion and the playbook document portion of each of the matched candidate pairs. The system may suggest modifications to the contract (e.g., modify) to better align the contract with the playbook. For example, the alignment may be a strict alignment (e.g., input document portion text to be the same or approximately the same as the playbook document portion for the matched candidate pairs) or a flexible alignment (e.g., input document portion to be similar to the playbook document portion for the matched candidate pairs). The system may allow the user the select and/or revise the suggested modifications, facilitating modification of the contract to conform the playbook.

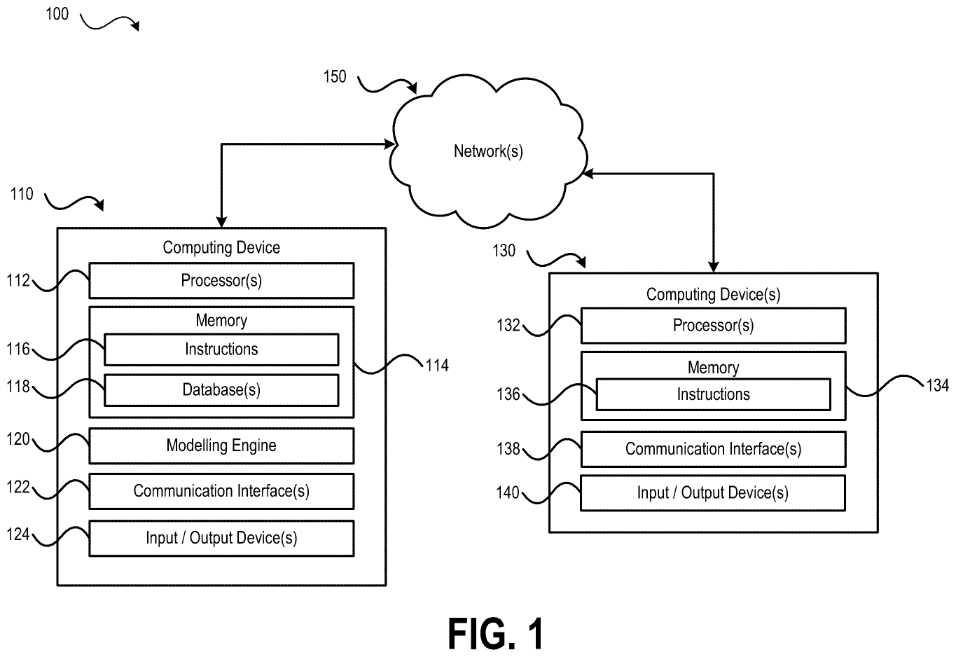

Referring to FIG. 1 a block diagram of a system operating in accordance with aspects of the present disclosure is shown as a system 100. The system 100 includes a computing device 110 configured to receive a document as input, such as from a computing device 130 via one or more networks 150, and to produce, as output, a new document comprising at least modification to the input document. For example, the input may be a contract and the output may be a revised contract having one or more altered contract provisions. As discussed herein, the computing device 110 may be configured to compare portions of an input document to a playbook defining pre-determined document portions to identify differences in the various document portions of the input document relative to the playbook, quantify those differences, and then generate a modified version of the input document including one or more new document portions based at least in part on the comparisons and the quantified differences. It is noted that while FIG. 1 is primarily described with reference to functionality provided by computing device 110, it should be understood that the functionality described herein may be provided in a distributed computing environment, such as using a plurality of computing devices 110, or a cloud-based deployment.

As illustrated in FIG. 1, the computing device 110 includes one or more processors 112, a memory 114, a modelling engine 120, one or more communication interfaces 122, and input/output (I/O) devices 124. The one or more processors 112 may include a central processing unit (CPU), graphics processing unit (GPU), a microprocessor, a controller, a microcontroller, a plurality of microprocessors, an application-specific integrated circuit (ASIC), an application-specific standard product (ASSP), or any combination thereof. The memory 114 may comprise read only memory (ROM) devices, random access memory (RAM) devices, one or more hard disk drives (HDDs), flash memory devices, solid state drives (SSDs), other devices configured to store data in a persistent or non-persistent state, network memory, cloud memory, local memory, or a combination of different memory devices. The memory 114 may also store instructions 116 that, when executed by the one or more processors 112, cause the one or more processors 112 to perform operations described herein with respect to the functionality of the computing device 110 and the system 100. The memory 114 may further include one or more databases 118, which may store data associated with operations described herein with respect to the functionality of the computing device 110 and the system 100.

The communication interface(s) 122 may be configured to communicatively couple the computing device 110 to the one or more networks 150 via wired and/or wireless communication links according to one or more communication protocols or standards. The I/O devices 124 may include one or more display devices, a keyboard, a stylus, a scanner, one or more touchscreens, a mouse, a trackpad, a camera, one or more speakers, haptic feedback devices, or other types of devices that enable a user to receive information from or provide information to the computing device 110.

The one or more databases 118 may be configured to store information and/or documents. For example, the one or more databases 118 may include one or more databases storing document portions corresponding to one or more playbooks. As used herein the term “playbook” may refer to a set of document portions, such as sentences, paragraphs, and the like, corresponding to best practices, preferred clauses or phrases, or other guidelines related to textual content. For example, a playbook may contain various preferred clauses for inclusion in contracts, such as force majeure clauses, intellectual property assignment clauses, severability clauses, and the like. Other types of playbooks may also be designed for other types of documents or textual content (e.g., blog posts, social media posts, articles, etc.) if desired. Other types of data may also be stored in the one or more databases 118 to support the operations described herein. For example, training data to support training of one or more large language models, transformer models, and the like may also be stored at the one or more databases 118.

The modelling engine 120 may be configured to support operations for analyzing documents in accordance with the concepts described herein, as well as to quantify any differences between an input document or text content and one or more playbooks, and to modify input documents or text content. For example, the modelling engine 120 may be configured to identify a first plurality of document portions in a first document, such as an input document. Identifying the first plurality of document portions in the first document may be based on a large language model applicable to a plurality of document classifications. In some examples, identifying the first plurality of document portions in the first document may be based on a trained classification model associated with a class of the first document. The modelling engine 120 may also identify document portions for other forms of input besides documents, such as text inputs (i.e., text provided via a copy and paste or other form of input besides uploading a document file).

The modelling engine 120 may also be configured to generate a plurality of matched candidate pairs based on the first plurality of document portions and a plurality of pre-determined document portions distinct from the first plurality of document portions. For example, the plurality of pre-determined document portions may correspond to document portions associated with a playbook stored at the one or more databases 118. Each document portion pair may include a first document portion (i.e., a document portion identified from an input document or text) and a second document portion (i.e., a document portion identified from a playbook). In an aspect, a single document portion identified within the input may be associated with multiple matched candidate pairs due to similarities between the document portion and one or more portions of a playbook or playbooks. In an aspect, the matched candidate pairs may be converted to embeddings, as described herein.

The modelling engine 120 may also be configured to determine information representative of a relationship between the first document portion and the second document portion for each document portion pair. For example, a model may be used to compare the first document portions obtained to the corresponding second document portion(s) based on one or more criteria to determine similarities and differences between the first document portion and the second document portion. In an aspect, the information representative of the relationship between the first document portion and the second document portion for each document portion pair may include, for each document portion pair of the plurality of matched candidate pairs, a first score corresponding to one or more intrinsic properties of the first document portion and the second document portion and a second score corresponding to a difference between the first document portion and the second document portion. In an aspect, the modelling engine 120 may utilize a transformer model (e.g., bidirectional encoder representations from transformers ((BERT) transformer model or the like, natural language processing models, etc.) to determine the difference(s) between the first document portion and the second document portion.

The transformer model may be configured to utilize embeddings generated based on the first and second document portions to determine the differences. In an aspect, a first portion of a set of embeddings corresponding to the first document portion may be configured as a query parameter for the transformer model and an attention mechanism of the transformer model may be configured based on a second portion of the set of embeddings corresponding to the second document portion. The modelling engine 120 may also be configured to prune the set of embeddings to produce a pruned set of embeddings. The pruned set of embeddings may contain or retains only portions of the set of embeddings representative of on an output of the transformer model, thereby producing a reduced set of embeddings containing information relevant to the relationships (e.g., similarities and differences) between the first and second document portions of each document portion pair. A priority score may be generated for each document portion pair based on the one or more intrinsic properties and the differences between the first document portion and the second document portion.

The modelling engine 120 may also be configured to quantify the relationships between the plurality of matched candidate pairs based on the information representative of the relationship between the first document portion and the second document portion for each document portion pair. The quantification of the relationships may include generating data describing legal differences between a first document portion of at least one document portion pair and a second document portion of the at least one document portion pair using at least one large language model. For example, the legal differences may indicate the legal impact of differences between the language of a first document portion from the input document and a corresponding document portion from the playbook. In an aspect, the at least one large language model comprises a plurality of large language models and the data describing the legal differences is generated by different large language models of the plurality of large language models based on a ranking criterion. For example, each of the matched candidate pairs may be ranked (e.g., based on priority score) and different rankings may be used to identify different ones of the plurality of large language models for use in quantifying the relationships. The data describing legal differences may include a summary, a natural language description of the difference, a sentence explaining risk arising from the legal differences, a sentence explaining potential liabilities arising from the legal differences, or a combination thereof.

In an aspect, the modelling engine 120 may be configured to generate a prompt based on the first document, the plurality of pre-determined document portions, or both, and the prompt may be provided as an input to at least one the large language model top generate the data describing the legal differences. The data describing the legal differences may include a threshold number of outputs, each output corresponding to a particular document portion pair of the plurality of matched candidate pairs. For example, the outputs of the large language model(s) may be limited to a top five document portions. Various criteria can be used to determine the threshold number of outputs, such as predicted legal significance, degree of deviation from the playbook, other factors, or a combination thereof. The threshold number of outputs may be configurable.

The modelling engine 120 may also be configured to modify the first document to produce a second document comprising one or more new document portions. The one or more new documents portions may correspond to one or more of the plurality of pre-determined document portions and replace at least one of the first plurality of documents portions. Additionally, or alternatively, the one or more new documents portions may correspond to a middle-ground between one or more first document portion(s) and one or more of the plurality of pre-determined document portions. In an aspect, a large language model may be utilized to produce the second document. The modelling engine 120 may be configured to generate a prompt that may be provided, as input, to the large language model to generate the second document. The prompt may include parameters for configuring generation of the second document. For example, the parameters for configuring the second document may include a compliance parameter specifying whether the one or more new documents portions correspond to one or more of the plurality of pre-determined document portions or a compromise between a particular document portion of the first plurality of document portions and a corresponding one of the plurality of pre-determined document portions. The parameters of the prompt may additionally, or alternatively, include one or more annotated matched candidate pairs configured to control generation of the one or more new document portions. The parameters of the prompt may additionally or alternatively include contextual information associated with the first document, the plurality of pre-determined document portions, or both, and wherein the contextual information is configured to control generation of the one or more new document portions. The parameters of the prompt may additionally or alternatively include one or more of the matched candidate pairs. The parameters of the prompt may additionally or alternatively include explainability information.

As can be appreciated from the foregoing, the modelling engine 120 may support rapid analysis, comparison, and modification of input text, whether provided as a document or text content only, and facilitate automated generation of a revised and new document containing document portions that more closely or exactly adhere to one or more playbooks, which may include best practices for various types of document portions and the like. In an aspect, the new document may include track changes showing the changes to the document portions made by the modelling engine using the techniques described herein. In some aspects, multiple new documents may be created, where each document may contain a different set of modifications to the input (e.g., one of the new documents may strictly adhere to the playbook while another document may provide changes that are more of a middle ground between the playbook and the original document portions).

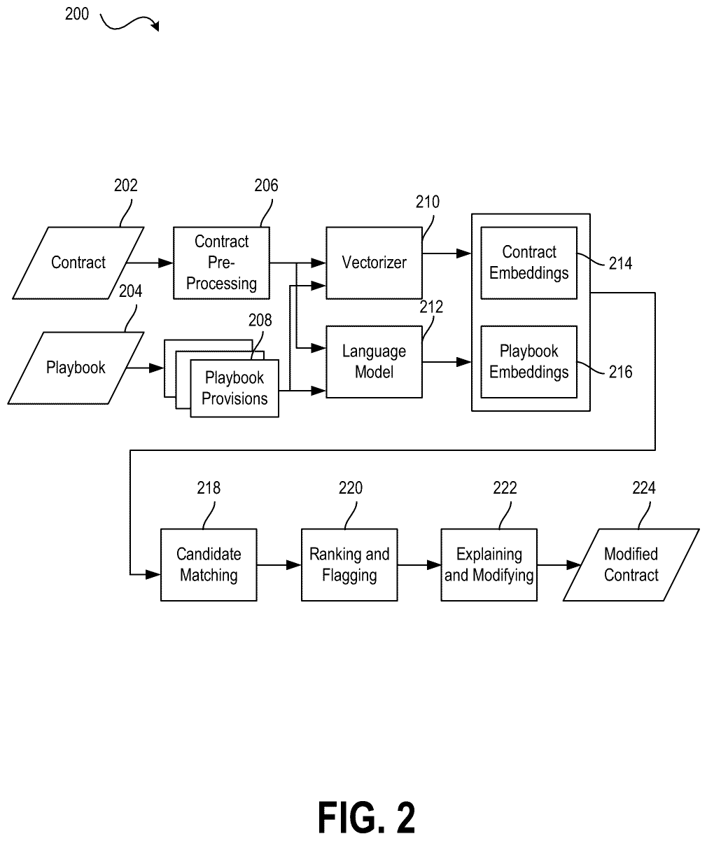

FIG. 2 is a flow diagram 200 for comparing and modifying documents in accordance with aspects of the present disclosure. The flow diagrams described herein, including the flow diagram 200, may implement aspects of or may be implemented by aspects of the system 100. In the following descriptions of flow diagrams described herein, including the flow diagram 200, the operations performed may be performed in different orders or at different times than the exemplary order shown. Some operations and/or components may also be omitted from the flow diagram 200, or other operations and/or components may be added to the flow diagram 200. The examples described herein are not to be construed as limiting, as the described features may be associated with any quantity of different devices. Although the techniques described herein are described with respect to a contract, the techniques may apply to any other type of document (e.g., employment contract, medical forms, service agreement, waiver forms, etc.).

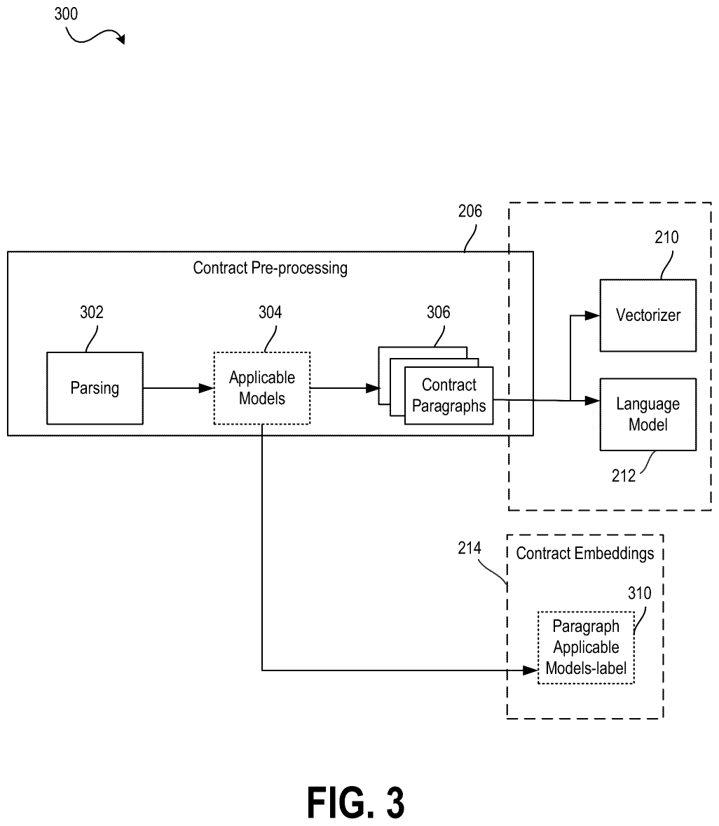

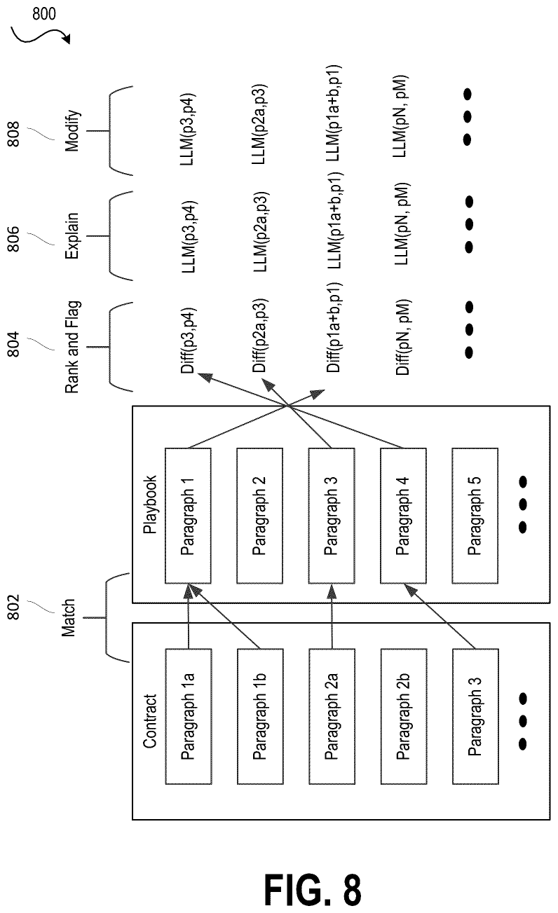

The flow diagram 200 for comparing and modifying documents may include a process of inputting a contract 202 into to a contract pre-processing process 206, which may operate as discussed in detail with respect to FIG. 3. The process may include identifying one or more document portions of the contract 202. The document portions may be passages of text (e.g., clauses or provisions), such as one or more paragraphs. The process may also include inputting a playbook 204 (e.g., guidelines of a company associated with the contract 202) and identifying various playbook provisions 208 (e.g., clauses, paragraphs, etc.). For example, the process may include identifying one or more document portions of the playbook, such as passages of text. The passages of text may correspond or relate to the input document portions, as described with respect to FIG. 8.

The output from the contract pre-processing process 206 and the playbook provisions 208 may each be inputs to a vectorizer 210 and a language model 212. The vectorizer 210 may be a TF-IDF vectorizer or the like that uses a statistical formula to convert text documents into vectors. Accordingly, the text from the processed input document portions of the contract 202 and the text from the playbook document portions of the playbook 204, such as the playbook provisions 208, may be converted into vectors.

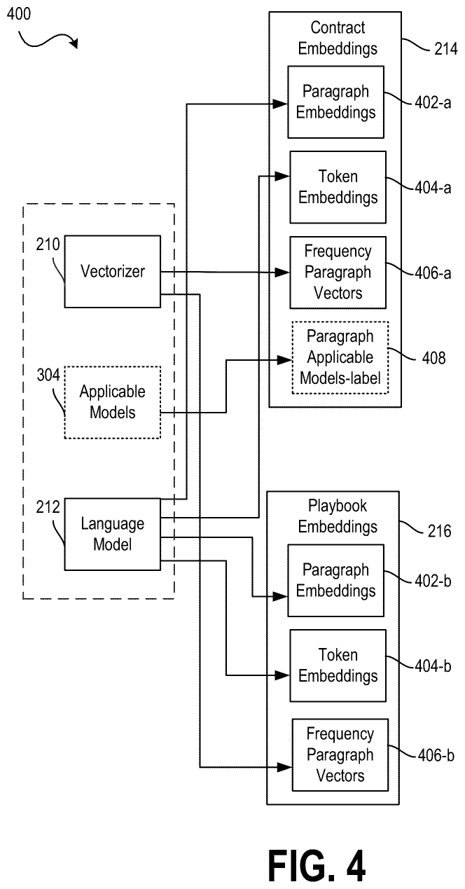

The language model 212 may include one or more transformers, natural language processing models, artificial intelligence models, machine learning models, and the like. For example, the language model 112 may include a sentence bidirectional encoder representations from transformers (sBERT). The language model 212 may take the words of the input document portions and the playbook document portions and represent them in the form of embeddings. The embeddings may be dense vector representation of the text. Accordingly, both the input document portions and the playbook document portions, may each be processed through a TF-IDF vectorizer and an sBERT. The output from the vectorizer 210 and the language model 212 may result in contract embeddings 214 and playbook embeddings 216 that each include paragraph embeddings, token embeddings, TF-IDF paragraph vectors, and/or paragraph thought-labels, as discussed in detail with respect to FIG. 4.

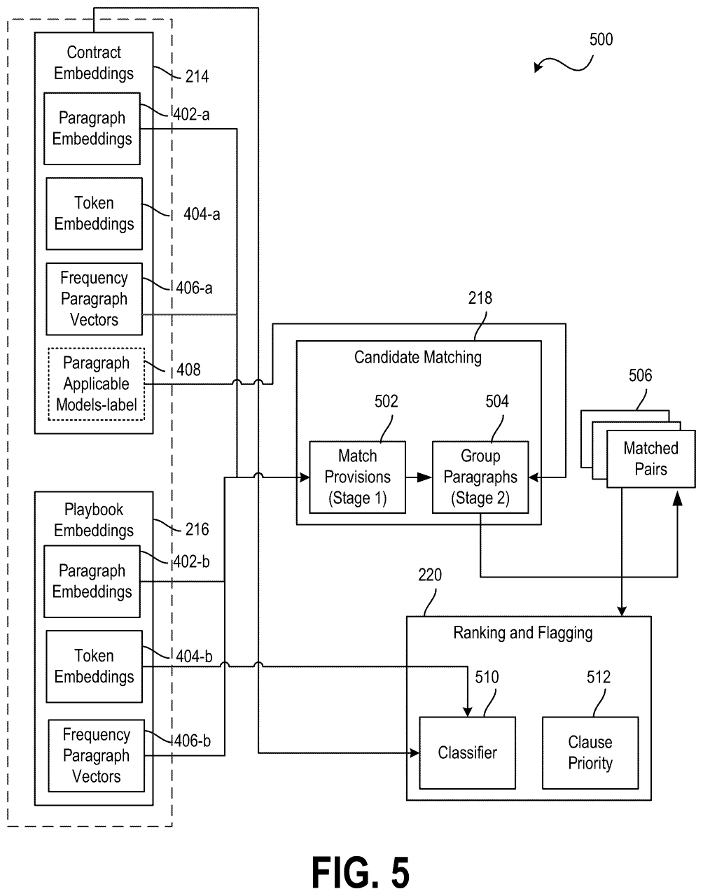

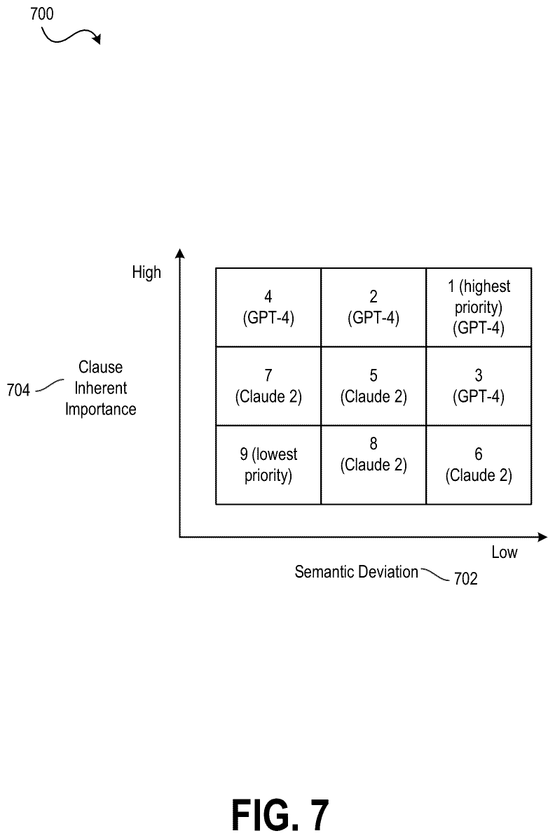

The contract embeddings 214 and the playbook embeddings 216 may be inputs to a candidate matching 218 process, as discussed in detail with respect to FIG. 5. The candidate matching may result in matched candidate pairs, where an input document portion (e.g., one or more passages or paragraphs) is paired with a playbook document portion. For example, a document portion pair will be matched to a corresponding playbook document portion (e.g., matching clauses between contract clause and playbook clause). The output of the candidate matching 218 may be an input to a ranking and flagging 220, as also discussed in detail with respect to FIG. 5. For example, ranking and flagging 220 the matched candidate pairs may be based on a priority of the pair. The priority may be determined via scoring each of the matched candidate pairs using one or more metrics, such as an intrinsic priority and/or semantic deviation, as discussed with respect to FIG. 7.

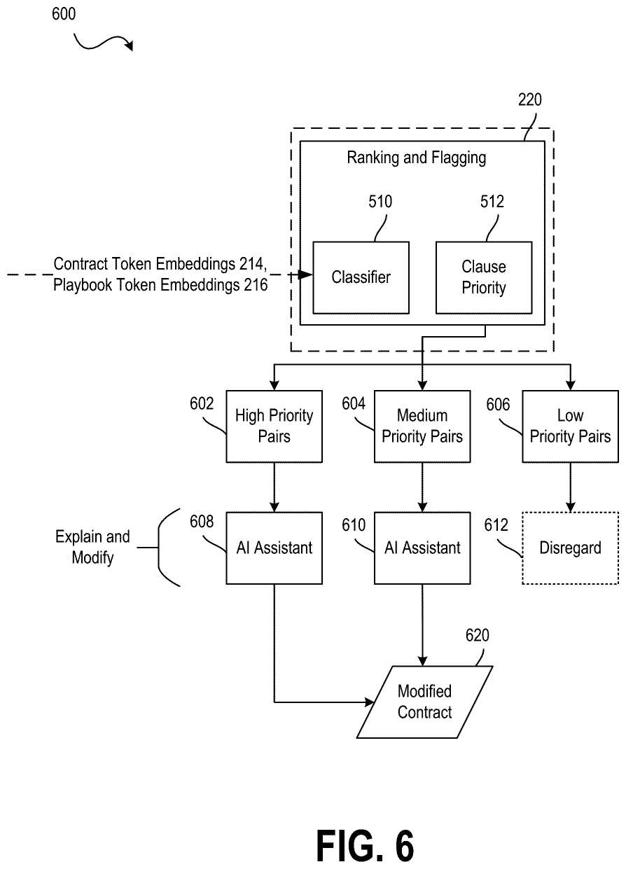

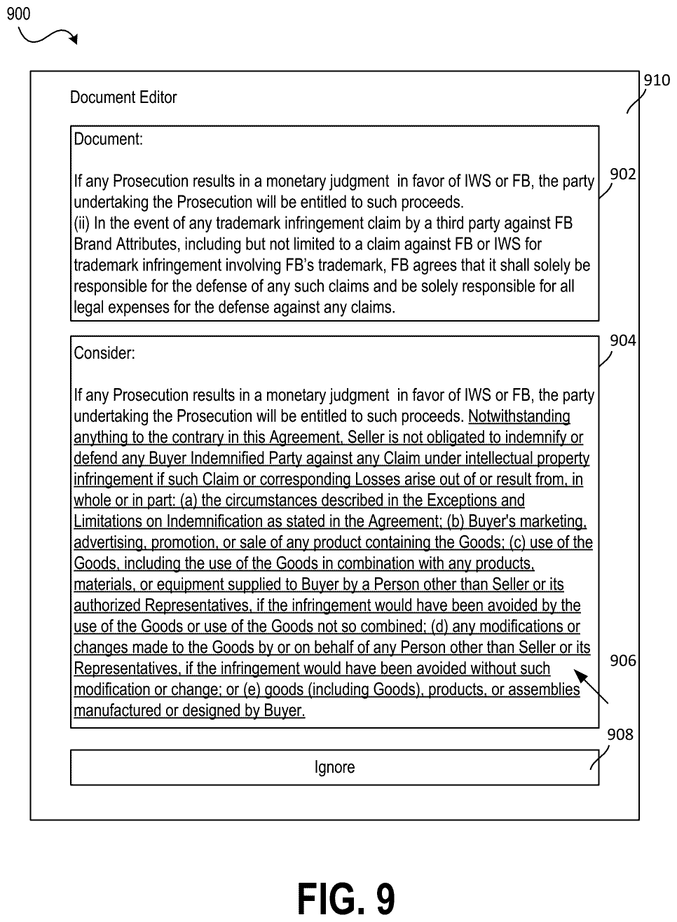

The output of the ranking and flagging 220 may be an input to explaining and modifying 222, as discussed in detail with respect to FIG. 6. The explaining and modifying 222 may include describing, in plain language, the differences between the input document portion and the playbook document portion for each of the matched candidate pairs. In some examples, the explaining and modifying 222 may include a description of the most important differences (e.g., top three differences) in the matched candidate pairs. As a result, the process may suggest modifying the input document portion so that it aligns with the playbook document portion. In some examples, a user may accept, revise, or reject the suggested modifications, as discussed in detail with respect to FIG. 9. Upon acceptance of the suggested or revised modifications to the input document portion, the process may output a modified contract 224. The suggested modifications may include application of the suggested or revised modifications to the input document portion. In this manner, the process depicted in FIG. 2 may facilitate efficient modifications to a contract so that the contract portions precisely conform to the playbook.

FIG. 3 is a flow diagram 300 for processing a document in accordance with aspects of the present disclosure. The flow diagram 300 may include a logic or parsing 302 process, using applicable models 304, and identifying contract paragraphs 306 (e.g., input document portions) as part of the contract pre-processing 206, as discussed with respect to FIG. 2.

In some examples, as indicated via the small circle dashed lines, the applicable models 304 may not be used in flow diagram 300 to identify the input documents portions in contract pre-processing 206. Accordingly, in such examples, as indicated via the small circle dashed lines and as discussed with detail with respect to FIG. 4, the contract embeddings 214 may not include paragraph applicable models-labels 310 that are an output of the applicable models 304.

The applicable models 304 may include trained classification models that are relevant to a specific class of document. For example, if the document is a contract, and more specifically an employment contract (e.g., class=employment contract), the applicable models 304 may include models that are applicable to employment contracts. Using models that are tailored to the specific classification of the document may result in an input document portion and a playbook document portion matching that is more precise than when using models that are universal and that may be applied to any classification of document. Accordingly, the applicable models 304 may include a large quantity of models that include models for each of the various classification of documents. The output of the applicable models 304 may be an input into contract embeddings 214 to provide paragraph applicable models-label 310.

In some examples, such as processing the input document portions without the applicable models 304, energy consumption and/or processing time of the system may be reduced. In such examples, the vectorizer 210 and/or the language model 212 may use more training data to continue providing accurate matching for the diverse classification of documents.

The parsing 302 process may include a logic or application that parses the text of the input document portion. In particular, the parsing 302 process may analyze the content of input document portion (e.g., passage of contract), such as text documents and/or images, to extract relevant data points and turn that into a usable format. For example, the parsing 302 process may take the input of an input document portion, such as a text passage, and parse it into smaller portions or extra relevant portions, such as single words or one or more words (e.g., less words than the passage). In some examples, the relevant portions may be converted into a different format (e.g., tokenized string) for further processing. The output of the parsing 302 process may be an input to the applicable models 304 when the contract pre-processing 206 includes the applicable models 304), and the output from the parsing 302 and/or the applicable models 304 may include contract paragraphs 306. The contract paragraphs 306 may be the document portions of the contract that are used for matching to the playbook document portions. The contract paragraphs 306 (e.g., input document portions) (and the playbook provisions of FIG. 2) may be inputs to the vectorizer 210 and/or the language model 212 and analyzed as discussed with respect to FIG. 2.

FIG. 4 is a flow diagram 400 for comparing matched candidate pairs of the document in accordance with aspects of the present disclosure. The input document portions and the playbook document portions may be processed as discussed with respect to FIG. 2 and FIG. 3, and the output from the vectorizer 210, the language model 212, and/or the applicable models 304 (when used), may result in the contract embeddings 214 and the playbook embeddings 216.

In order to evaluate semantic deviation between the input document portions (e.g., contract text) and the playbook document portions (e.g., playbook text), a model initially may generate token embeddings for both texts in each document portion pair. The token embeddings 404 may be dense vector representations of individual words (or tokens) in the text, and they may be generated through the application of the embedding layer within a transformer model, such as the language model 212 (e.g., sBERT). The embeddings may be designed to capture contextual information of the tokens, allowing the model to infer semantic and syntactic relationships between them, as further described with respect to FIG. 6 and FIG. 7.

The output from the vectorizer 210 after vectorizing input document portions (e.g., contract paragraphs 306 of FIG. 3), may include frequency paragraph vectors 406-a of the contract embeddings 214. The output from the vectorizer 210 after vectorizing the playbook document portions (e.g., playbook provisions 208 of FIG. 2), may include frequency paragraph vectors 406-b of the playbook embeddings 216.

The output from the language model 212 after receiving input document portions (e.g., contract paragraphs 306 of FIG. 3), may include paragraph embeddings 402-a and token embeddings 404-a of the contract embeddings 214. The output from the language model 212 after receiving the playbook document portions (e.g., playbook provisions 208 of FIG. 2), may include paragraph embeddings 402-b and token embeddings 404-b of the playbook embeddings 216. In some examples (as indicated by the small circle dashed line), the applicable models 304 that receives input document portions may output paragraph applicable model-label 408, which may be specific context labels pertaining to the classification of the document (e.g., type of contract). The labels may be used for matching and forming the matched candidate pairs.

FIG. 5 is a flow diagram 500 for matching matched candidate pairs of the document in accordance with aspects of the present disclosure. To match matched candidate pairs, the paragraph embeddings 402-a and the frequency paragraph vectors 406-a of the contract embeddings 214, as well as the paragraph embeddings 402-b and the frequency paragraph vectors 406-b of the playbook embeddings 216, are inputs to a first match provisions process 502 of candidate matching 218. In the first match provisions process 502 (stage 1 of matching), each of the input document portions, such as clauses or paragraphs of the input document, may be matched (e.g., based on similarity or semantic deviations) to clauses or paragraphs of the playbook document portions, as discussed with respect to FIG. 8. In particular, for a given a playbook clause, the first match provisions process 502 may calculate the similarity score against all contract provisions and indicate the pair of clauses with the highest score (e.g., above a score threshold).

The output of the first match provisions process 502 may be an input to a group paragraphs process 504 (stage 2). In some examples, the paragraph applicable models-label 408 may also be an input to the group paragraphs process 504. The group paragraphs process 504 may group multiple paragraphs or clauses. For example, group paragraphs process 504 may include performing a local search on neighboring contract provisions with the same thought type for each of the contract provisions. As an example, a first clause of the playbook may be matched to section 1.01 of a contract via the matching provisions process 502, and then the first clause of the playbook may be further matched with neighboring section 1.02 and section 1.03. Thus, the first clause may be matched to sections 1.01, 1.02, and 1.03 by the first match provisions process 502 and the group paragraphs process 504. Accordingly, the output of the candidate matching 218, which includes the first match provisions process 502 and the group paragraphs process 504, may provide an indication of the matched pairs 506. In some examples, the group paragraphs process 504 may also provide an indication of the match pair with the highest or top highest similarity scores (e.g., top three highest similarity scores).

The ranking and flagging 220 receives an input of the matched pairs 206, which are the matched candidate pairs of one or more input document portions and corresponding one or more playbook document portions, as described with respect to FIG. 6. The ranking and flagging 220 includes a classifier 510 and a clause priority process 512. The classifier 510 may be a cross-attention classifier. The ranking and flagging 220 may also receive an input of the token embeddings 404-b of the playbook embeddings 216 and the contract embeddings 214. As discussed herein, the matched pairs 506 may be ranked and flag based on their priority for further examination. The ranking and flagging may be based on scoring each of the contract-playbook matched pairs 506 using two distinct metrics: (1) intrinsic priority and (2) semantic deviation.

The intrinsic priority metric may assign a low priority, medium priority, or high priority to each of the matched pairs 506 based on the category or classification of the playbook clause. For instance, clauses related to indemnity may receive a high priority score, while severability clauses may receive a low score. The priority scores may be predetermined by legal professionals and assigned to the matched pairs 506 by looking up the appropriate category for each of the matched pairs 506.

This semantic deviation metric may be determined using a natural language processing model, a transformer-based language model, or the like, such as a BERT-like model. The BERT-like model is a transformer-based model and the transformer architecture includes several layers of multi-headed, self-attention mechanisms that may capture complex relationships between words in textual input.

In some examples, to quantify the semantic deviation between the playbook provisions and contract provisions (e.g., input document portions and the playbook document portions), a cross-attention classification may be used. The classifier 510 may include a mechanism to assess the relationships between two separate sequences of text (i.e., the input document portions and the playbook document portions, that may be clauses or paragraphs). For example, in the cross-attention classifying process, the token embeddings 404-b of the playbook may be considered to be queries, while the token embeddings 404-a of the contract text may be considered as key-values in the attention mechanism. The query-key-value architecture may refer to a method used within a transformer model of the ranking and flagging 220 to capture dependencies and relationships between words in a text sequence. The cross-attention mechanism here may use the query (e.g., playbook) embeddings to selectively focus on relevant key (e.g., contract) embeddings, assigning higher weight to keys that are most related to the query. This weighting, when combined with the corresponding values (contract embeddings), may produce a contextually aware result that highlights areas of semantic similarity or dissimilarity.

Following a classification head that integrates the embedded information from either portion of the document-portion-pair, and classifies the pair for their semantic deviation via the classifier 510, the classifier 510 may compute a summary of the cross-attention outputs in the form of a fixed-dimension vector through converting a sequence of embeddings into a sentence embedding (e.g., referred to as “pooling”), including max-pooling and the classify token vector (CLS-vector) (e.g., first vector in a sequence). The pooled vector may retain the most representative information or features from the cross-attention output of the classifier 510. The fixed-dimension vector may be subsequently processed by a binary classification head, which may be a neural network-based classifier that estimates whether the playbook and contract clauses (e.g., document portions) are materially different (indicating a high semantic deviation) or if they are effectively paraphrases with no significant implications (implying a low semantic deviation), such as low legal implications.

By providing a more detailed representation of token embeddings, cross-attention, and the query-key-value mechanism, the techniques discussed herein may ensure that the semantic deviation measurement and its application in the ranking and flagging 220 are distinct from other mechanisms, as well as more precise.

One or more models of the clause priority process 512 may be used to determine the intrinsic priority scores. The intrinsic priority scores and the semantic deviation scores may be combined to produce a single priority score. This combined score may determine which matched pairs 506 have high priority, indicating that the matched pairs may be considered for review. Accordingly, high matched pairs 506 (e.g., matched candidate pairs) may be flagged for user review. In some examples, low priority matched pairs 506 may be disregarded for efficiency in reviewing.

FIG. 6 is a flow diagram 600 for ranking matched candidate pairs of the document in accordance with aspects of the present disclosure. The ranked matched pairs from the ranking and flagging 220 may be classified as high priority pairs 602, medium priority pairs 604, or low priority pairs 606, and each of the pairs may include a document input portion and a playbook document portion (e.g., one or more contract paragraphs and one playbook provision). One or more of the high priority pairs 602, medium priority pairs 604, and low priority pairs 606, such as the highest-priority pairs in some examples, may be processed for a streamlined explanation component. For example, the high priority pairs 602 may be processed through an artificial intelligence assistant 608, such as large language models, generative pre-trained transformer 4 (GTP-4), or the like. The medium priority pairs 604 may be processed through another artificial intelligence assistant 610, such as large language models, Claude 2, or the like. The large language models utilize deep learning techniques to generate human-like text representations. The large language models may be pretrained on a large quantity of textual data to generate contextually relevant embeddings and understand linguistic patterns. For example, the large language models may be employed to identify and describe the top critical differences (for explaining the differences), such as the top one-to-five most critical legal differences, between the contract text and the playbook document portions. In some examples, each of the top one-to-five most critical legal differences may be given a confidence score of low, medium, or high. The score may provide an indication of the confidence level that the large language models have in generating the differences. The scores may be provided alongside the explanations, as discussed herein.

In some examples, for explaining the differences, text prompts may be inputted (e.g., prompt engineering where inputs or prompts are designed to guide artificial intelligence models to produce specific outputs) into the large language models to stimulate an expected response from the large language models. In the present invention, prompt engineering may incorporate “in-context” learning, such as by supplying the large language models with two examples of the task and the desired output format. The large language models may generate outputs in the form of an itemized list of top differences.

Each difference or explanation may include three parts including a concise summary section heading (e.g., “No COVID-19 Event in Force Majeure”), a natural language processing of the difference, and a concluding sentence explaining the risk and potential liabilities that may arise due to the discrepancy. In some examples, context from the broader contract and playbook may be provided to the large language models, such that the exposition of differences may draw from other terms or conditions in the playbook and or contract. In some examples, the large language models may produce such differences (e.g., one to five differences) in an “issues list” that is provided on a user interface (e.g., in the word processor program, in line with the contract draft). The differences in the issues list may be presented to users in order of priority.

Suggestions to modify the contract may also be provided, as described in detail with respect to FIG. 9. For example, suggested modifications may be provided on the user interface. The modifications may be accepted, ignored, or adjusted (e.g., via user input), and the contract may be modified accordingly to a modified contract 620. In some examples, the low priority pairs 606 may be disregarded 612 (e.g., not provided in the issues list).

FIG. 7 is a graph diagram 700 for scoring matched candidate pairs (e.g., ranking) in accordance with aspects of the present disclosure. The graph diagram 700 depicts priority, such as priority of 1 through 9, for matched candidate pairs of an input document portion and a playbook document portion. The priority, which may be based on intrinsic priority and semantic deviation, may be efficiently indicated. For example, the highest priority deviation in matched pairs may be indicated to user while lowest priority deviation in matched pairs may not be indicated (e.g., threshold-out lowest-priority deviations). Not including each of the matched pairs of all matched pairs may reduce energy consumption of the system, while also reduce review time for the reviewer. In some examples, the priority may be represented by an overall score (e.g., including scores of both the intrinsic priority and semantic deviation) and scores may be compared between documents for efficient review. Additionally, the highest-priority deviations (e.g., priority 1-4) may be sent to an artificial intelligence assistant, such as a GPT-4, which may be costly while lower-priority deviations (e.g., priority 5-8) may be sent to a less costly artificial intelligence assistant, such as Clause 2 or GPT-3.5. The highest priority may be based on small textual changes in important clauses.

The graph diagram 700 may have an x-axis of semantic deviation 702 between the matched pairs and a y-axis of clause inherent importance 704 (e.g., priority). The combination of the lowest semantic deviation 702 and greatest clause inherent importance 704 may be a pair that falls at the top right side of the graph diagram 700, as indicated by “1,” having the highest priority. Alternatively, the combination of the greatest semantic deviation 702 and the least clause inherent importance 704 may be a pair that falls at the bottom left side of the graph diagram 700, as indicated by “9,” having the lowest priority.

The list of priority for the clause inherent important 704 may be a list of priority clauses, ranked by SMEs. The semantic deviation 702 may be based on a sentence transformer model, such as a sentence bidirectional encoder representation from transformers (sBERT). The clause intrinsic priority may be determined based on SMEs and large language models. For SMEs, small textual changes in important pairs may score high in overall priority. Clause intrinsic priorities may be based on ontology, which may be set and modified by users. Clause intrinsic priorities may be based on large language models. The GPT-4 may automatically label priorities. For examples, thought-fields may be categorized into bins 1, 2, and 3 via the GPT-4. The semantic deviation 702 may focus on deviants versus paraphrase. For examples, if the texts of the pairs are syntactically different but materially the same (e.g., paraphrased), the pair may not be flagged (e.g., not high priority). However, if the texts of the pairs are syntactically similar but materially different (e.g., deviant), the pair may be flagged (e.g., high priority). In some examples, for semantic deviation 702, the models used may include an sBERT for candidate matching and cross-attention classifying, and a cross-attention classifier for outputting deviation scores.

FIG. 8 is a system diagram for analyzing and modifying matched candidate pairs of the document in accordance with aspects of the present disclosure. The techniques discussed herein may be categorized into a matching process 802, a ranking and flagging process 804, an explaining process 806, and a modifying process 808. In some examples, each of these processes may involve using large language models and/or instructing or guiding the large language models.

Using the techniques discussed herein with respect to matching, the matching process 802 may result in one or more clauses of the contract (e.g., an input document portion), such as paragraphs, that are paired to a clause of the playbook (e.g., a playbook document portion). For example, paragraph 1a and paragraph 1b of the contract may both match (e.g., based on scoring) to paragraph 1 of the playbook, paragraph 2a of the contract may match to paragraph 3 of the playbook, and paragraph 3 of the contract may match to paragraph 4 of the playbook.

Using the techniques discussed herein with respect to ranking and flagging, the ranking and flagging process 804 may result in ranking and flagging the pairs based on differences between the matched candidate pairs. For example, the difference between paragraph 3 of the contract and paragraph 4 of the playbook may result in the highest priority of the pairs. The difference between paragraph 2a of the contract and paragraph 3 of the playbook may result in a second highest priority of the pairs. The difference between paragraph 1a and 1b of the contract and paragraph 1 of the playbook may result in a third highest priority of the pairs. The ranking and flagging may continue for additional pairs for N paragraphs of the contract and M paragraphs of the playbook (Diff (pN, pM)) (e.g., 1-5 highest priorities).

Using the techniques discussed herein with respect to explaining, the explaining process 806 may result in explaining the differences for each of the flagged pairs. In some examples, the explanations may be generated using large language models or the like models. Using the techniques discussed herein with respect to modifying and as discussed in detail with respect to FIG. 9, the modifying process 808 may result in proposed modifications that may be accepted, rejected, or adjusted by the user. The suggested modifications may be generated using large language models or the like models.

FIG. 9 is an example 900 of a suggested modification of the matched candidate pairs in accordance with aspects of the present disclosure. The example 900 may include a user interface 910 displaying a document editor. The document editor may display the original document 902 or portion of the document being modified. The document editor may also display a modification suggestion 904 that indicates the suggested modifications based on the differences between the matched candidate pairs, priority, and so forth, as discussed herein. In some examples, the modification suggestion 904 may provide an indication of the changes to the user, such as the additional text or removed texts with respect to the original document 902. For example, the modification suggestion 904 may be underlined, colored, highlighted, bolded, stricken, and so forth. In this manner, the user may efficiently review and modify the text originally inputted in the original document. The user may also provide user input 906, such as via a mouse selection. In some examples, the user may select the modification suggestion 904 and input any changes to the modification suggestion 904. For example, the user may remove at least a portion of the suggested text or change some of the words. In some examples, the user may select an ignore button 908 to ignore the modification suggestion 904.

The user may select a selectable option, such as the original document 902, the modification suggestion 904, or the ignore button 908. Upon selection via the user input 906 or hovering over a selectable option, the option may be boldened, change color, or may otherwise indicate selection to the user. The document editor may appear at the top, middle, or bottom of the user interface. For example, the document editor (e.g., portion considered for modification) may appear inline with the draft contract or may overlay the draft contract.

Generating the modification suggestion 904 may involve large language models, for example, to rewrite or revise the contract, such as by aligning the contract with clauses and terms present in the corporate playbook. For higher-priority contract-playbook provision pairs, the GPT-4 large language model is may be used while Claude2 large language model may be utilized for lower-priority pairs. In some examples, generating the modification suggestion 904 may involve instructing or guiding the large language model.

The modify component of the techniques discussed herein may include generating multiple alternative versions of the revised contract paragraphs for each high-priority pair. The versions may include a strict compliance version or a flexible compliance version. The strict compliance version may include the large language model producing a contract text that adheres strictly to the provisions and terms outlined in the playbook (e.g., above a threshold text match), offering the most favorable or predictable conditions for the user by complying with the playbook. However, such a strict level of compliance may lead to negotiation challenges and demands. Thus, in some examples, a flexible compliance version may be used. The flexible compliance version may represent a compromise between the original contract and the playbook clauses. The large language model may be used to rewrite the contract by incorporating elements that may be agreeable to both the playbook drafting attorney and the contract drafting attorney. To provide such strict compliance and/or flexible compliance versions of the suggested modifications, the large language models may use engineered input prompts. The prompts may incorporate several elements that guide the large language models in producing the intended output in the relevant format.

For example, the format may include few-shot examples. The few-shot examples prompt may include several annotated examples of other exemplary contract-playbook pairs, demonstrating the intended alignment model the large language model is expected to follow. Few-shot learning is a machine learning paradigm where the model generalizes from a limited set of examples, as opposed to a more extensive annotated dataset. The format may include a broader context. The broader context prompt may include additional context from the broader contract and playbook to help the large language model comprehend the contract-playbook pair better and to infer relationships and semantic information from surrounding clauses and provisions. The format may include a target contract-playbook pair. The large language models may be provided with the specific contract-playbook pair that is compared, for example, as used for explaining differences in the pairs. The format may include a prior step output. The results obtained from the explaining components may be integrated into the prompt for modifying component. By adding these explanations and differences back into the prompt, the large language model's performance may be improved through a technique known as prompt-chaining, wherein the outputs of one step are used as inputs for the subsequent step.

Using these elements in the input prompts, the large language model may generate the revised versions of the contract paragraphs, adhering to either strict or flexible compliance as intended by the user. Once the user selects a preferred version, the user may seamlessly integrate the revised contract clause, such as the contract paragraph, into the word document. By integrating the revised clause into the contract, the contract may be more compliant with the playbook provisions and limiting potential legal risks. Moreover, such revisions may be objective rather than subjective to the user, ensuring compliance.

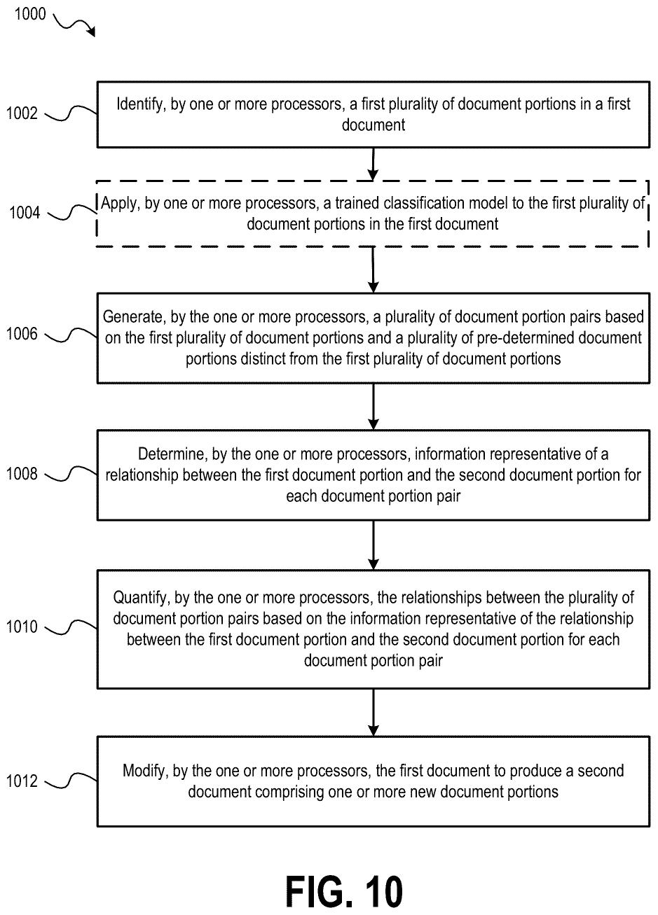

Referring to FIG. 10, a flow diagram of an exemplary method for automated document modification in accordance with aspects of the present disclosure is shown as a method 1000. In an aspect, the method 1000 may be performed by a computing device, such as the computing device 110 having a modelling engine 120 configured in accordance with aspects of the present disclosure. In an aspect, steps of the method 1000 may be stored as instructions that, when executed by one or more processors, cause the one or more processors to perform operations of the method 200 and the concepts described herein.

At step 1002, the method 1000 includes identifying, by one or more processors, a first plurality of document portions in a first document. As explained above, the first document may be a document file or may merely be text input. In some examples (as indicated by the dashed line) at step 1004, the method 1000 includes applying, by one or more processors, a trained classification model (e.g., the though-extractor) to identify the first plurality of document portions in the first document. In some examples, additionally or alternatively to using the though-extractor the first plurality of document portions, large language models may be used to identify the first plurality of document portions, as discussed above.

At step 1006, the method 1000 includes generating, by the one or more processors, a plurality of matched candidate pairs based on the first plurality of document portions and a plurality of pre-determined document portions distinct from the first plurality of document portions. As explained above, each document portion pair may include a first document portion and a second document portion, where the first document portion of a particular document portion pair corresponds to one of the first plurality of document portions and the second document portion of the particular document portion pair corresponds to one of the plurality of pre-determined document portions.

At step 1008, the method 1000 includes determining, by the one or more processors, information representative of a relationship between the first document portion and the second document portion for each document portion pair. At step 1010, the method 1000 includes quantifying, by the one or more processors, the relationships between the plurality of matched candidate pairs based on the information representative of the relationship between the first document portion and the second document portion for each document portion pair. At step 1012, the method 1000 includes modifying, by the one or more processors, the first document to produce a second document having one or more new (e.g., modified) document portions. The one or more new documents portions may correspond to or be associated with one or more of the plurality of pre-determined document portions and may replace at least one of the first plurality of documents portions within the new document. That is to say, the new document may contain some document portions that are identical to document portions included in the first document received as input, but also includes one or more document portions that have been modified (i.e., are not the same as) the corresponding document portions of the first document received as input. The method 1000 may additionally or alternatively include steps described with respect to FIG. 1 (e.g., as performed by the modelling engine 120 of FIG. 1).

In one or more aspects, the functions described may be implemented in hardware, digital electronic circuitry, computer software, firmware, including the structures disclosed in this specification and their structural equivalents thereof, or any combination thereof. Implementations of the subject matter described in this specification also may be implemented as one or more computer programs, that is one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that may be enabled to transfer a computer program from one place to another. A storage media may be any available media that may be accessed by a computer. By way of example, and not limitation, such computer-readable media can include random-access memory (RAM), read-only memory (ROM), electrically erasable programmable read-only memory (EEPROM), CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, hard disk, solid state disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. Computer-readable storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, a connection may be properly termed a computer-readable medium. For example, if the software is transmitted from a website, server, or other remote source using a coaxial cable, fiber optic cable, twisted pair, or digital subscriber line (DSL), then the coaxial cable, fiber optic cable, twisted pair, or DSL, are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, some other implementations are within the scope of the following claims. In some cases, the actions recited in the claims may be performed in a different order and still achieve desirable results.

As used herein, including in the claims, various terminology is for the purpose of describing particular implementations only and is not intended to be limiting of implementations. For example, as used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term). The term “coupled” is defined as connected, although not necessarily directly, and not necessarily mechanically; two items that are “coupled” may be unitary with each other. The term “or,” when used in a list of two or more items, means that any one of the listed items may be employed by itself, or any combination of two or more of the listed items may be employed. For example, if a composition is described as containing components A, B, or C, the composition may contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof. The term “substantially” is defined as largely but not necessarily wholly what is specified—and includes what is specified; e.g., substantially 90 degrees includes 90 degrees and substantially parallel includes parallel—as understood by a person of ordinary skill in the art. In any disclosed aspect, the term “substantially” may be substituted with “within [a percentage] of” what is specified, where the percentage includes 0.1, 1, 5, and 10 percent; and the term “approximately” may be substituted with “within 10 percent of” what is specified. The phrase “and/or” means and or.

The terms “comprise” (and any form of comprise, such as “comprises” and “comprising”), “have” (and any form of have, such as “has” and “having”), and “include” (and any form of include, such as “includes” and “including”) are open-ended linking verbs. As a result, an apparatus or system that “comprises,” “has,” or “includes” one or more elements possesses those one or more elements, but is not limited to possessing only those elements. Likewise, a method that “comprises,” “has,” or “includes,” one or more steps possesses those one or more steps, but is not limited to possessing only those one or more steps.

Although the aspects of the present disclosure and their advantages have been described in detail, it should be understood that various changes, substitutions and alterations can be made herein without departing from the spirit of the disclosure as defined by the appended claims. Moreover, the scope of the present application is not intended to be limited to the particular implementations of the process, machine, manufacture, composition of matter, means, methods and processes described in the specification. As one of ordinary skill in the art will readily appreciate from the present disclosure, processes, machines, manufacture, compositions of matter, means, methods, or operations, presently existing or later to be developed that perform substantially the same function or achieve substantially the same result as the corresponding aspects described herein may be utilized according to the present disclosure. Accordingly, the appended claims are intended to include within their scope such processes, machines, manufacture, compositions of matter, means, methods, or operations.

1. A method comprising:
identifying, by one or more processors, a first plurality of document portions in a first document;
generating, by the one or more processors, a plurality of matched candidate pairs based on the first plurality of document portions and a plurality of pre-determined document portions distinct from the first plurality of document portions, wherein each document portion pair comprises a first document portion and a second document portion, the first document portion of a particular document portion pair corresponding to one of the first plurality of document portions and the second document portion of the particular document portion pair corresponding to one of the plurality of pre-determined document portions;
determining, by the one or more processors, information representative of a relationship between the first document portion and the second document portion for each document portion pair;
quantifying, by the one or more processors, the relationships between the plurality of matched candidate pairs based on the information representative of the relationship between the first document portion and the second document portion for each document portion pair; and
modifying, by the one or more processors, the first document to produce a second document comprising one or more new document portions, wherein the one or more new documents portions correspond to one or more of the plurality of pre-determined document portions and replace at least one of the first plurality of documents portions.

2. The method of claim 1, wherein identifying, by the one or more processors, the first plurality of document portions in the first document is based at least in part on a large language model applicable to a plurality of document classifications.

3. The method of claim 1, wherein identifying, by the one or more processors, the first plurality of document portions in the first document is based at least in part on a trained classification model associated with a class of the first document.

4. The method of claim 1, wherein the information representative of the relationship between the first document portion and the second document portion for each document portion pair comprises, for each document portion pair of the plurality of matched candidate pairs, a first score corresponding to one or more intrinsic properties of the first document portion and the second document portion and a second score corresponding to a difference between the first document portion and the second document portion.

5. The method of claim 4, further comprising generating a set of embeddings for the plurality of matched candidate pairs, wherein each embedding of the set of embeddings corresponds to a particular document portion pair of the plurality of matched candidate pairs, and wherein the information representative of the relationship between the first document portion and the second document portion of each document portion pair is determined based on the set of embeddings.

6. The method of claim 5, wherein the difference between the first document portion and the second document portion is determined based on the set of embeddings using a transformer model.

7. The method of claim 6, wherein a first portion of the set of embeddings corresponding to the first document portion is configured as a query parameter for the transformer model and an attention mechanism of the transformer model is configured based on a second portion of the set of embeddings corresponding to the second document portion.

8. The method of claim 6, further comprising pruning the set of embeddings to produce a pruned set of embeddings, wherein the pruned set of embeddings retains portions of the set of embeddings representative of on an output of the transformer model.

9. The method of claim 4, further comprising generating a priority score for each document portion pair of the plurality of matched candidate pairs based on the one or more intrinsic properties and the difference between the first document portion and the second document portion.

10. The method of claim 9, further comprising ranking the plurality of matched candidate pairs based on the priority score.

11. The method of claim 1, further comprising generating data describing legal differences between a first document portion of at least one document portion pair and a second document portion of the at least one document portion pair using at least one large language model.

12. The method of claim 11, wherein the at least one large language model comprises a plurality of large language models, and wherein the data describing the legal differences is generated by different large language models of the plurality of large language models based on a ranking criterion.

13. The method of claim 11, wherein the data describing legal differences comprises a summary, a natural language description of the difference, a sentence explaining risk arising from the legal differences, a sentence explaining potential liabilities arising from the legal differences, or a combination thereof.

14. The method of claim 11, further comprising generating a prompt based on the first document, the plurality of pre-determined document portions, or both, wherein the prompt is provided as an input to at least one the large language model.

15. The method of claim 11, wherein the data describing the legal differences comprises a threshold number of outputs, each output corresponding to a particular document portion pair of the plurality of matched candidate pairs.

16. The method of claim 15, wherein the threshold number of outputs is configurable.

17. An apparatus, comprising:
a memory controller of a host device configured to couple the host device to a memory system through a first interface, the memory controller configured to perform operations including:
identifying, a first plurality of document portions in a first document;
generating a plurality of matched candidate pairs based on the first plurality of document portions and a plurality of pre-determined document portions distinct from the first plurality of document portions, wherein each document portion pair comprises a first document portion and a second document portion, the first document portion of a particular document portion pair corresponding to one of the first plurality of document portions and the second document portion of the particular document portion pair corresponding to one of the plurality of pre-determined document portions;
determining information representative of a relationship between the first document portion and the second document portion for each document portion pair;
quantifying the relationships between the plurality of matched candidate pairs based on the information representative of the relationship between the first document portion and the second document portion for each document portion pair; and
modifying the first document to produce a second document comprising one or more new document portions, wherein the one or more new documents portions correspond to one or more of the plurality of pre-determined document portions and replace at least one of the first plurality of documents portions.

18. The apparatus of claim 17, wherein identifying the first plurality of document portions in the first document is based at least in part on a large language model applicable to a plurality of document classifications.

19. The apparatus of claim 17, wherein identifying the first plurality of document portions in the first document is based at least in part on a trained classification model associated with a class of the first document.

20. A non-transitory computer-readable medium having code that, when executed by one or more processors, causes the one or more processors to:
identify, a first plurality of document portions in a first document;
generate a plurality of matched candidate pairs based on the first plurality of document portions and a plurality of pre-determined document portions distinct from the first plurality of document portions, wherein each document portion pair comprises a first document portion and a second document portion, the first document portion of a particular document portion pair corresponding to one of the first plurality of document portions and the second document portion of the particular document portion pair corresponding to one of the plurality of pre-determined document portions;
determine information representative of a relationship between the first document portion and the second document portion for each document portion pair;
quantify the relationships between the plurality of matched candidate pairs based on the information representative of the relationship between the first document portion and the second document portion for each document portion pair; and
modify the first document to produce a second document comprising one or more new document portions, wherein the one or more new documents portions correspond to one or more of the plurality of pre-determined document portions and replace at least one of the first plurality of documents portions.
